(19) United States
(12) Patent Application Publication
(10) Pub. No.: US 2012/0331504 A1
(43) Pub. Date: Dec. 27, 2012

(54) APPARATUS AND METHOD FOR EXECUTING APPLICATION IN MOBILE TERMINAL PROVIDING BROADCAST RECEIVING SERVICE

(75) Inventor: Sung-Wook Byun, Suwon-si (KR)

(73) Assignee: SAMSUNG ELECTRONICS CO., LTD., Suwon-si (KR)

(21) Appl. No.: 13/531,351

(22) Filed: Jun. 22, 2012

(30) Foreign Application Priority Data
Jun. 22, 2011 (KR) 10-2011-0060656

(51) Int. Cl. H04N 21/61; H04N 21/462

(52) U.S. Cl. 725/39; 725/62

(57) ABSTRACT

A mobile terminal provides a broadcast receive service. More particularly, an apparatus and a method executes an application installed in advance via a channel change of a broadcast service. The apparatus includes a communication unit, a channel register unit, a channel determining unit, a memory unit, and a controller. The communication unit communicates with a remote controller to receive a control signal of the remote controller. A channel register unit registers an application installed in advance in a broadcast channel allocated to the mobile terminal to update channel information. A channel determining unit determines a channel changed by a user's remote controller manipulation. A memory unit stores channel information updated by the channel register unit. A controller processes to execute an application depending on a channel change of the remote controller. The channel determining unit determines the channel information to determine an application registered in the changed channel.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Jun. 22, 2011 and assigned Serial No. 10-2011-0060656, the entire disclosure of which is hereby incorporated by reference.

### TECHNICAL FIELD OF THE INVENTION

The present disclosure relates to a mobile terminal for providing a broadcast receive service.

### BACKGROUND OF THE INVENTION

Recently, as mobile terminals develop rapidly, a mobile terminal that allows wireless voice communication and information exchange has become a daily necessity. In an early stage of distribution, a mobile terminal was simply recognized as a product that can be carried and that enables wireless communication. As technology developed and wireless Internet was introduced, the mobile terminal gradually expanded its utilization range to include games, remote control using short distance communication, and image capturing using a mounted digital camera, in addition to the familiar functions of simple telephone communication or schedule management.

Furthermore, with development of a digital broadcast technology, a mobile terminal that supports receiving digital broadcasts has been developed to allow a user to view digital multimedia broadcasting while moving. This development has drawn much attention from users.

To view the digital broadcast using the mobile terminal, a user should select and view a desired broadcast among broadcasts that can be viewed currently.

In addition, mobile terminals may install one or more applications that provide a function for use by a user besides those functions provided by the manufacturing company.

Furthermore, a terminal (for example, a smart TV) that provides a broadcast service may install one or more applications to support games, a widget, flash, and the like, besides the broadcast service.

To execute an application in the mobile terminal, a user should enter a menu screen providing a list of applications installed in advance and then select a menu which the user desires to execute.

At this point, the user of the mobile terminal inputs a directional key for selecting a menu to select the menu which the user desires to execute. However, when the number of types of applications installed in the mobile terminal increases, a frequency of inputs of a user's directional key increases,

Therefore, to solve the above problem, an apparatus and a method for simplifying a process for executing an application in a mobile terminal are required.

### SUMMARY OF THE INVENTION

To address the above-discussed deficiencies of the prior art, it is a primary object to provide at least the advantages described below. Accordingly, an aspect of the present disclosure is to provide an apparatus and a method for simplifying a process for executing an application in a mobile terminal.

Another aspect of the present disclosure is to provide an apparatus and a method for executing an application via a channel change in a mobile terminal.

Still another aspect of the present disclosure is to provide an apparatus and a method for registering an application in a channel in which broadcasting is not received in a mobile terminal.

In accordance with an aspect of the present disclosure, an apparatus for executing an application of a mobile terminal providing a broadcast receive service is provided. The apparatus includes a channel register unit configured to register an application installed in advance in a broadcast channel allocated to the mobile terminal, and a channel determining unit configured to execute an application registered in a broadcast channel to be changed in response to a user's channel change request.

In accordance with another aspect of the present disclosure, a method for executing an application of a mobile terminal providing a broadcast receive service is provided. The method includes registering an application installed in advance in a broadcast channel allocated to the mobile terminal, and executing an application registered in a broadcast channel to be changed in response to a user's channel change request.

In accordance with still another aspect of the present disclosure, a mobile terminal for providing a broadcast receive service is provided. The mobile terminal includes a communication unit configured to communicate with a remote controller to receive a control signal of the remote controller. The mobile terminal also includes a channel register unit configured to register an application installed in advance in a broadcast channel allocated to the mobile terminal to update channel information. The mobile terminal further includes a channel determining unit configured to determine a channel selected by a user's remote controller manipulation. The mobile terminal still further includes a memory unit configured to store channel information updated by the channel register unit. The mobile terminal also includes a controller configured to process to execute an application depending on a channel change of the remote controller, wherein the channel determining unit determines the channel information to determine an application registered in the changed channel.

Other aspects, advantages and salient features of the disclosure will become apparent to those skilled in the art from the following detailed description, which, taken in conjunction with the annexed drawings, discloses exemplary embodiments of the disclosure.

Before undertaking the DETAILED DESCRIPTION OF THE INVENTION below, it may be advantageous to set forth definitions of certain words and phrases used throughout this patent document; the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 an illustrates a mobile terminal that executes an application via a channel change according to an embodiment of the present disclosure;

FIG. 2 illustrates a process for performing application registration in a mobile terminal according to an embodiment of the present disclosure;

FIG. 3 illustrates a process for editing a registered application in a mobile terminal according to an embodiment of the present disclosure;

FIG. 4 illustrates a process for executing an application in a mobile terminal according to an embodiment of the present disclosure;

FIG. 5A illustrates a process for executing an application in the conventional mobile terminal;

FIG. 5B illustrates a process for registering an application in a mobile terminal according to an embodiment of the present disclosure; and

FIG. 5C illustrates a process for executing an application in a mobile terminal according to an embodiment of the present disclosure.

Throughout the drawings, like reference numerals will be understood to refer to like parts, components and structures.

### DETAILED DESCRIPTION OF THE INVENTION

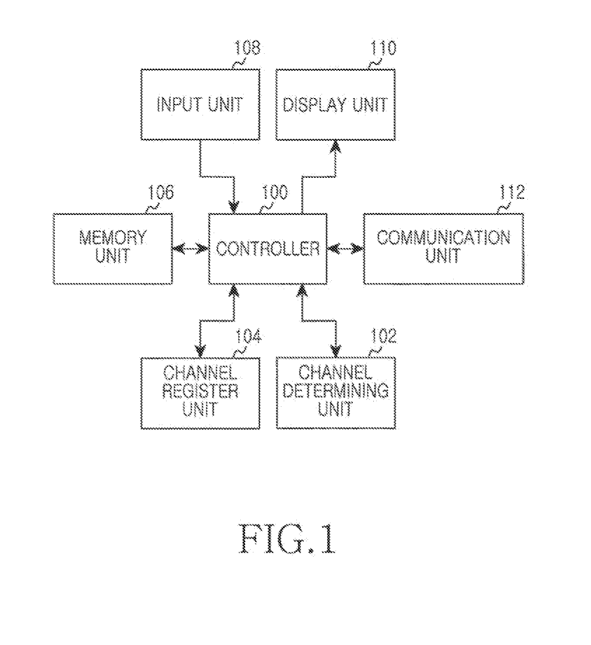

FIGS. 1 through 5C, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The following description with reference to the accompanying drawings is provided to assist in a comprehensive understanding of exemplary embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. Also, descriptions of well-known functions and constructions are omitted for clarity and conciseness.

The present invention relates to an apparatus and a method for executing an application installed in advance via a channel change of a broadcast service.

Exemplary embodiments of the present disclosure provide an apparatus and a method for registering an application in a channel in which broadcasting is not received, and executing an application using a channel change in a mobile terminal. In addition, the mobile terminal denotes an output device that can receive broadcasting, and includes a television (TV), a Digital Multimedia Broadcasting (DMB) receiving apparatus, a notebook, and the like. In the following description, it is assumed that the mobile terminal is a mobile communication terminal providing a broadcast receive service.

FIG. 1 is a block diagram illustrating a mobile terminal that executes an application via a channel change according to an embodiment of the present disclosure.

Referring to FIG. 1, the mobile terminal includes a controller 100, a channel determining unit 102, a channel register unit 104, a memory unit 106, an input unit 108, a display unit 110, and a communication unit 112.

The controller 100 of the mobile terminal controls an overall operation of the mobile terminal. For example, the controller 100 performs a process and a control for data communication. In addition to the general functions, the controller 100 provides a broadcast service, and changes a channel of a provided broadcast service via a remote controller function. In addition, the controller 100 may set an application installed in advance to a channel in which broadcasting is not received to process to allow the application to be executed in a channel change manner. That is, the controller 100 may process to allow the application registered in advance to be executed via broadcast channel selection using the remote controller. Also, the method described hereunder of the present invention may be provided as one or more instructions in one or more software modules stored in the storage device. The software modules may be executed by the controller.

The channel determining unit 102 determines a channel that a user desires to change under control of the controller 100. That is, the channel determining unit 102 determines channel information regarding broadcasting allocated to the mobile terminal, and determines a channel changed in response to the user's request to perform a channel change. In addition, the channel determining unit 102 determines and executes an application registered in the channel changed in response to the user's request. This denotes that the channel determining unit 102 may execute the application registered in the channel changed in response to the user's channel change request.

The channel register unit 104 registers an application installed in advance in a broadcast channel of the mobile terminal under control of the controller 100. That is, the channel register unit 104 registers the application installed in advance in a channel to which broadcasting has not been allocated among broadcast channels supported by the mobile terminal, and then processes to update information of the channel in which the application has been registered. In some embodiments, the channel determining unit 102 and/or the channel register unit 104 may be implemented as another controller(s).

The memory unit 106 includes Read Only Memory (ROM), Random Access Memory (RAM), and a flash ROM. The ROM stores microcode of programs for processes and controls of the controller 100, the channel determining unit 102, and the channel register unit 104, and various reference data.

The RAM serves as a working memory of the controller 100 and stores temporary data that occur during execution of various programs, In addition, the flash ROM stores various updatable data for storage such as a phonebook, calling messages, and received messages. According to an embodiment of the present disclosure, the flash ROM stores channel information in which the application or broadcasting has been registered.

The method executed by the channel determining unit 102 and/or the channel register unit 104 may be provided as one or more instructions in one or more software modules stored in the memory unit 106. In that situation, the software modules may be executed by the controller unit 100.

The input unit 108 includes a plurality of function keys such as numerical key buttons of 0 to 9, a menu button, a cancel button, an OK button, an END button, an Internet access button, navigation key buttons, character input keys, and the like, and provides key input data corresponding to a key pressed by the user to the controller 100. In addition, the input unit 108 generates input data requesting an application to be registered in a broadcast channel.

The display unit 110 displays state information occurring during an operation of the mobile terminal, characters, moving images, still images, and the like. The display unit 110 may be a color Liquid Crystal Display (LCD), an Active Matrix Organic Light-Emitting Diode (AMOLED), and the like. The display unit 110 may include a touch input device, and when it is applied to a touch input type mobile terminal, the display unit 110 can be used as an input unit. In addition, according to an embodiment of the present disclosure, the display unit 110 outputs an application executed depending on a channel change, and outputs an application registering process. A touch sensitive display, also known as a touch screen, may be used as the display unit 110. In this situation, touch input may be performed via the touch sensitive display.

The communication unit 112 transmits and receives a wired/Radio Frequency (RF) signal of data input and output via an antenna (not shown). For example, during transmission, the communication unit 112 channel-codes and spreads data to be transmitted, and then performs an RF process on the signal to transmit the signal. During reception, the communication unit 112 converts a received RF signal into a baseband signal, and despreads and channel-decodes the baseband signal to recover data. In addition, according to an embodiment of the present disclosure, the communication unit 112 connects to the remote controller to receive the user's channel change request.

The functions of the channel determining unit 102 and the channel register unit 104 may be performed by the controller 100 of the mobile terminal. The separate configuration and illustration of the channel determining unit 102 and the channel register unit 104 represent one example for convenience in description, and are not intended to limit the scope of the present disclosure. It would be obvious to those skilled in the art that various modifications may be made within the scope of the present disclosure. For example, all functions of the channel determining unit 102 and the channel register unit 104 may be processed by the controller 100.

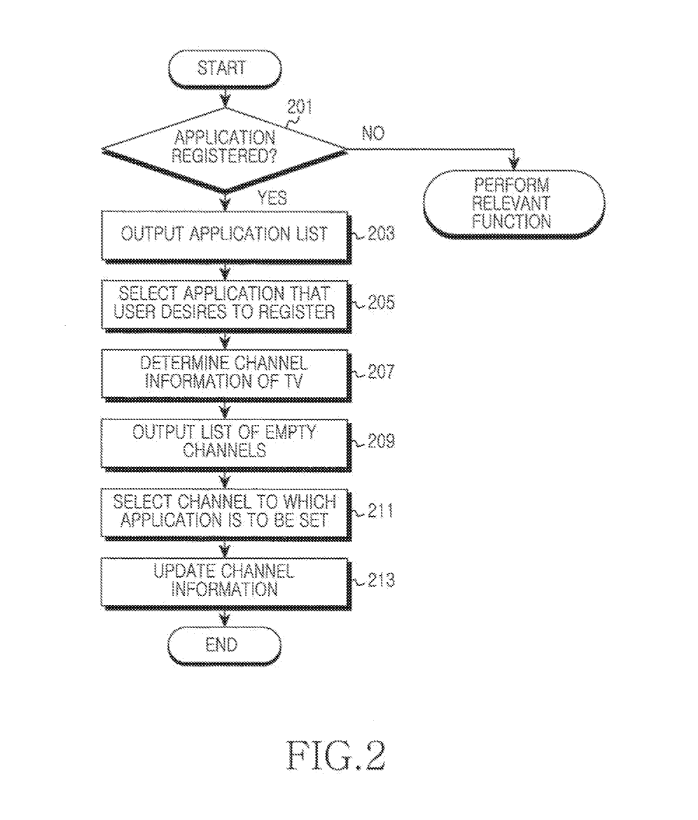

FIG. 2 is a flowchart illustrating a process for performing application registration in a mobile terminal according to an embodiment of the present disclosure.

The application registration process is to register an application installed in advance in a broadcast channel allocated to the mobile terminal. This is for executing the application registered in the channel via a channel change using a remote controller capable of controlling a mobile terminal.

Referring to FIG. 2, the mobile terminal determines whether to perform an application register process in block 201.

Upon a determination not to perform an application register process in block 201, the mobile terminal performs a relevant function (for example, a broadcast output process, and the like).

Alternatively, upon a determination to perform an application register process in block 201, the mobile terminal proceeds to block 203 to output a list of applications, and proceeds to block 205 to allow a user to select an application to be registered in a channel of the mobile terminal. In addition, the mobile terminal may proceed to block 205 while searching for the list of applications on a menu screen.

The mobile terminal proceeds to block 207 to determine channel information of the mobile terminal. Here, the channel information denotes information regarding broadcast channels supported by the mobile terminal. According to an embodiment of the present disclosure, the mobile terminal may register an application in a channel to which broadcasting has not been allocated and execute the application registered in the channel via a channel change,

The mobile terminal proceeds to block 209 to output a list of empty channels. Here, the channel information may include channels to which an application or broadcasting has been allocated, and channels to which the application or the broadcasting has not been allocated. A channel to which the application or the broadcasting has not been allocated is defined as an empty channel.

The mobile terminal proceeds to block 211 to select a channel in which the application selected in block 205 is to be registered among the empty channels and register the application in the channel, and proceeds to block 213 to update the channel information. That is, the mobile terminal deletes the channel in which the application has been registered from the list of the empty channels.

After that, the mobile terminal ends the present algorithm.

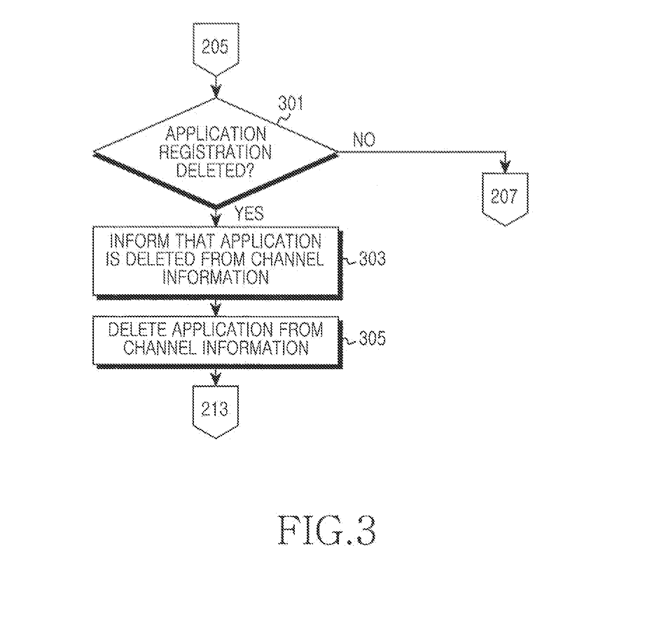

FIG. 3 is a flowchart illustrating a process for editing a registered application in a mobile terminal according to an embodiment of the present disclosure.

Referring to FIG. 3, when an application to be registered in a channel of the mobile terminal is selected in block 205 of FIG. 2, the mobile terminal determines whether to delete the application registration or whether to change the channel in which the application has been registered in block 301. Here, the deleting of the application registration or the changing of the channel may be performed by selecting a menu output after the application is selected.

When the mobile terminal determines to change the channel in which the application has been registered in block 301, the mobile terminal proceeds to block 207 of FIG. 2 to perform an application registration process.

Alternatively, when the mobile terminal determines to delete the application registration in block 301, the mobile terminal proceeds to block 303 to output an alarm message informing that the application is deleted from the channel information, and proceeds to block 305 to delete the application from the channel information. At this point, the mobile terminal outputs the alarm message informing that the application is deleted, and then receives a user's delete request to perform a process of block 305.

The mobile terminal that has deleted the application from the channel information proceeds to block 213 of FIG. 2 to update the channel information. That is, the mobile terminal replaces the channel from which the application has been deleted with an empty channel.

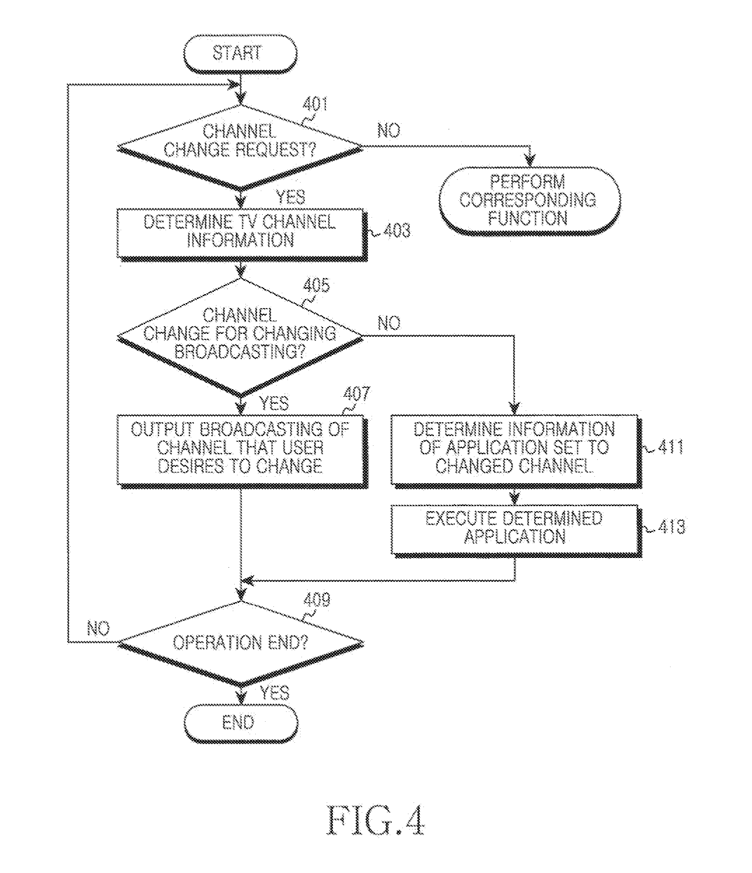

FIG. 4 is a flowchart illustrating a process for executing an application in a mobile terminal according to an embodiment of the present disclosure.

Referring to FIG. 4, the mobile terminal determines whether a channel change is requested in block 401. Here, the mobile terminal determines whether a user's channel change request transmitted via a remote controller or a remote controller application is received. The mobile terminal receives a request for a channel increase, a channel decrease, or a change request to a channel selected in person.

When a channel change is not requested in block 401, the mobile terminal performs a relevant function (for example, maintain broadcast output).

Alternatively, when the channel change is requested in block 401, the mobile terminal proceeds to block 403 to determine channel information of the mobile terminal, and proceeds to block 405 to determine if the channel information is a channel change for changing broadcasting. This is, the mobile terminal determines whether broadcasting is provided from a channel changed by a user, or whether an application is registered in a channel where broadcasting is not received.

When the mobile terminal determines that the channel information is the channel change for changing broadcasting in block 405, the mobile terminal proceeds to block 407 to output broadcasting of a channel which the mobile terminal desires to change.

Alternatively, when the mobile terminal determines that the channel information is not the channel change for changing broadcasting in block 405, the mobile terminal proceeds to block 411 to determine information of an application set to the changed channel, and proceeds to block 413 to execute the application which the mobile terminal desires to change.

The mobile terminal that has performed the operation of block 407 or block 413 proceeds to block 409 to determine whether an operation of the mobile terminal ends.

When the mobile terminal determines that the operation of the mobile terminal does not end in block 413, the mobile terminal re-performs the process of block 401.

Alternatively, when the mobile terminal determines that the operation of the mobile terminal ends in block 413, the mobile terminal ends the present algorithm.

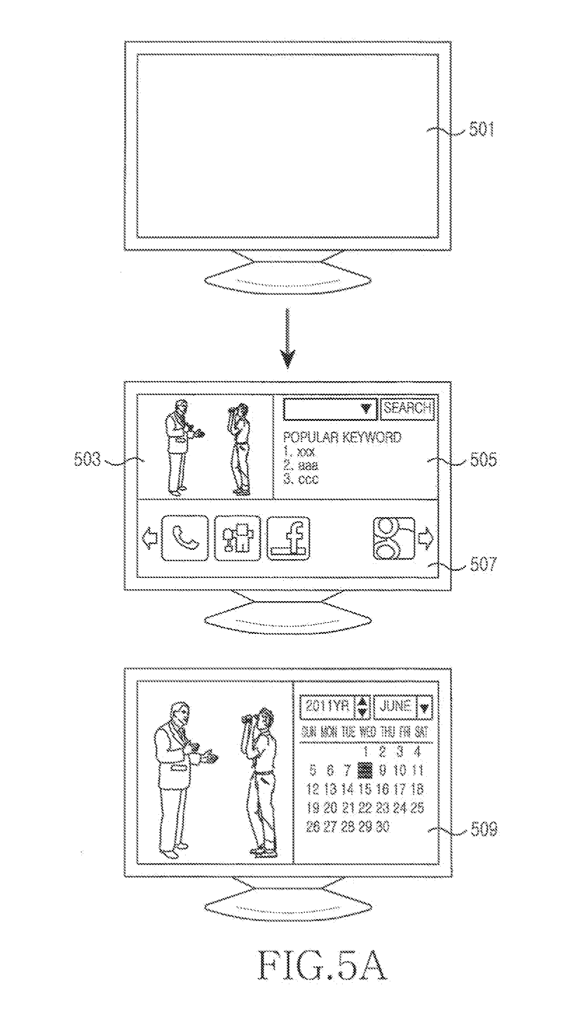

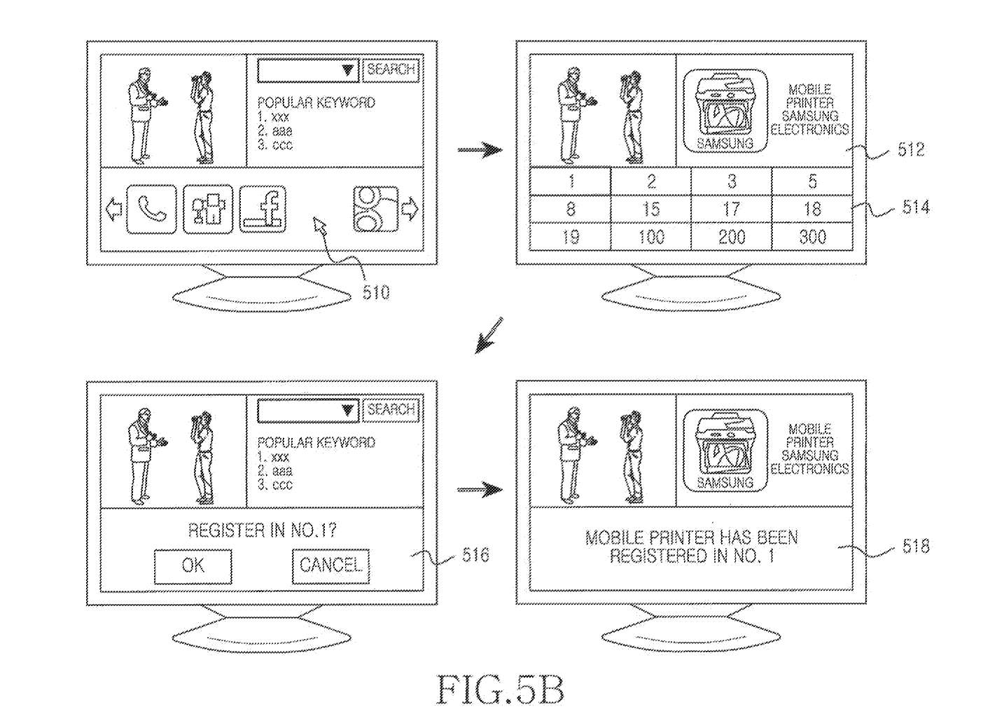

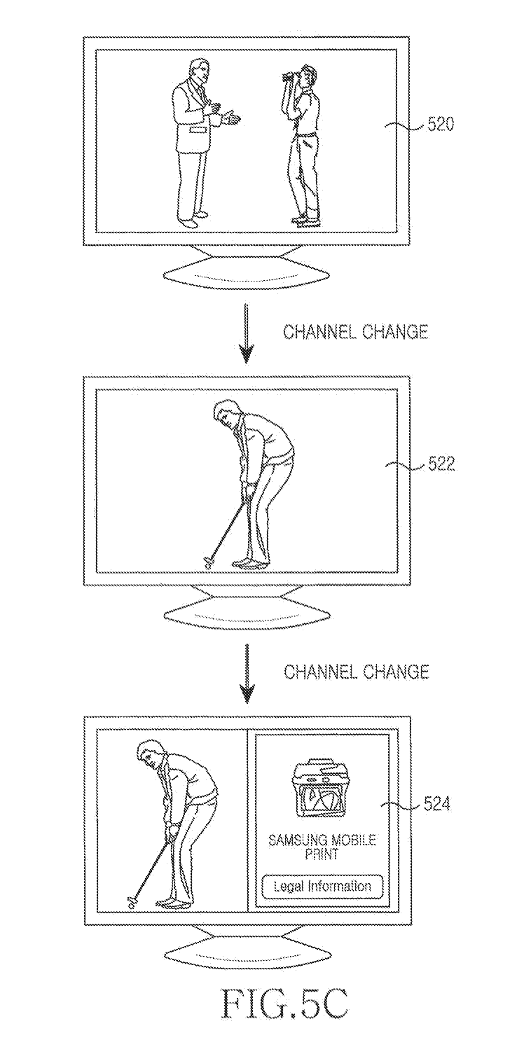

FIGS. 5A through 5C are views comparing operation processes of a mobile terminal executing an application.

FIG. 5A is a view illustrating a process for executing an application in the conventional mobile terminal.

Referring to FIG. 5A, the mobile terminal outputs broadcasting of a currently set channel as illustrated at 501.

After that, a user of the mobile terminal enters a menu screen for controlling a function of the mobile terminal. The menu screen may be divided into a region 503 for reducing and outputting broadcasting output in advance, a search region 505 for Internet search, and a region 507 for outputting a list of applications installed in advance.

When a user of the mobile terminal intends to execute an application while viewing output broadcasting, the user should enter the menu screen and then select an application that the user desires to execute using a directional key.

When the user of the mobile terminal intends to execute an application for schedule management, the user selects and executes the schedule manage application 509 by inputting a plurality of directional keys. Accordingly, the mobile terminal outputs an execute screen of the schedule manage application on a portion of the region of the mobile terminal as illustrated. At this point, the mobile terminal may allow broadcasting output in advance to be output together with the application.

However, as the number of applications or the number of types of applications installed in the mobile terminal increases, a frequency of a user's inputting directional keys increases.

FIG. 5B is a view illustrating a process for registering an application in a mobile terminal according to an embodiment of the present disclosure.

Referring to FIG. 5B, the mobile terminal outputs the list of applications installed in advance on the menu screen as described above. At this point, the mobile terminal registers an application in a channel supported by the mobile terminal to allow the application to be executed via channel selection or channel change. For example, the user of the mobile terminal may select an application that the user desires to register by using a navigation button of the terminal providing a remote controller or a remote controller application, or moving a mouse pointer 510.

When the user of the mobile terminal selects an application that the user desires to register, the mobile terminal determines information regarding a channel in which the selected application can be registered. That is, the mobile terminal outputs brief information 512 (a producing company, an application name, a purpose, and the like) regarding the application selected by the user. In addition, the mobile terminal outputs information 514 regarding a channel or channels in which the selected application can be registered.

The information 514 regarding the channel(s) denotes information regarding a channel where broadcasting received in the mobile terminal does not exist. That is, channels 1, 2, 3, 5, and so forth, are channels that do not receive broadcasting provided by sky waves, a wired line, and a cable broadcasting company; and a channel not included in the information denotes a channel where currently received broadcasting exists.

In addition, when a user selects a channel 100 among the information regarding the channel(s), the mobile terminal provides information regarding channels where received broadcasting does not exist among channels 100 to 199. Similarly, according to the above method, the user of the mobile terminal may determine information regarding channels 200-299, 300-399, and the like, by selecting other channels.

When the user of the mobile terminal selects a mobile printer application and then selects a channel 1 as a channel that the user desires to register, the mobile terminal pops up a message 516 inquiring whether to register the application in the channel 1.

When the option “not register” is selected in the message 516, the mobile terminal maintains the channel 1 as an empty channel. When the option “register” is selected in the message 516, the mobile terminal registers the mobile printer application in the channel 1.

At this point, the mobile terminal outputs information 518 regarding the application registered in the channel and the channel in which the application has been registered.

FIG. 5C is a view illustrating a process for executing an application in a mobile terminal according to an embodiment of the present disclosure.

Referring to FIG. 5C, the mobile terminal outputs broadcasting of a currently set channel as illustrated at 520.

After that, when receiving a user's channel change request, the mobile terminal changes a channel set in advance to a channel 522 corresponding to the received request. At this point, the user's channel change request is to receive a channel change request transmitted via a remote controller or a remote controller application that can control the mobile terminal, and receive an input of a channel change button included in the mobile terminal.

At this point, the mobile terminal analyzes a channel changed according to the channel change request to determine whether broadcasting is received from the changed channel. When the mobile terminal determines that the channel is changed to a channel where broadcasting is received, the mobile terminal receives and outputs the broadcasting received via the changed channel.

However, when the mobile terminal determines that the channel is changed to a channel where broadcasting is not received, the mobile terminal determines the application registered in the changed channel to execute the relevant application 524.

The mobile terminal may perform a channel change via the above-described user's remote controller manipulation. According to an embodiment of the present disclosure, when a user requests an Electronic Program Guide (EPG), the mobile terminal outputs channel information regarding received broadcasting. In addition, the mobile terminal provides information regarding a channel in which an application has been registered. Therefore, the user of the mobile terminal selects channel information included in the output EPG to view relevant broadcasting, and in addition, selects a channel in which an application has been registered to execute the relevant application.

It will be appreciated that embodiments of the present invention can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention. Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

As described above, the present disclosure provides a simplified application execute process in a mobile terminal. The present disclosure registers an application in a channel where broadcasting is not received, and then executes an application using a channel change that uses a remote controller, so that a user does not need to search for an application that the user desires to execute in person.

Although the disclosure has been shown and described with reference to certain exemplary embodiments thereof, it will be understood by those skilled in the art that various changes in form and details may be made therein without departing from the spirit and scope of the disclosure as defined by the appended claims and their equivalents. Therefore, the scope of the present disclosure should not be limited to the above-described embodiments but should be determined by not only the appended claims but also the equivalents thereof.

What is claimed is:

1. An apparatus for executing an application of a mobile terminal providing a broadcast receive service, the apparatus comprising:
a channel register unit configured to register an application installed in advance in a broadcast channel allocated to the mobile terminal; and
a channel determining unit configured to execute an application registered in a broadcast channel to be changed in response to a user's channel change request.

2. The apparatus of claim 1, further comprising:
a controller configured to provide channel information in which the application has been registered,
wherein the controller provides Electronic Program Guide (EPG) information together with the channel information in which the application has been registered.

3. The apparatus of claim 1, wherein the channel register unit registers the application in a channel where the application or broadcasting has not been registered among broadcast channels allocated to the mobile terminal.

4. The apparatus of claim 1, wherein:
the channel determining unit determines a broadcast channel to be changed in response to the channel change request,
when the changed broadcast channel is a channel where broadcasting is received, the channel determining unit receives the broadcasting of the relevant channel, and
when the changed broadcast channel is a channel in which an application has been registered, the channel determining unit executes the application registered in the relevant channel.

5. The apparatus of claim 1, the channel determining unit further configured to determine broadcast channel information.

6. The apparatus of claim 1, further comprising:
an input unit configured to receive a channel change request from a user.

7. The apparatus of claim 6, further comprising:
a display unit configured to display the requested channel.

8. A method for executing an application of a mobile terminal providing a broadcast receive service, the method comprising:
registering an application installed in advance in a broadcast channel allocated to the mobile terminal; and
executing an application registered in a broadcast channel to be changed in response to a user's channel change request.

9. The method of claim 8, further comprising:
providing channel information in which the application has been registered,
wherein the channel information in which the application has been registered is provided together with Electronic Program Guide (EPG) information.

10. The method of claim 8, wherein registering an application installed in advance in a broadcast channel allocated to the mobile terminal comprises:
registering the application in a channel where the application or broadcasting has not been registered among broadcast channels allocated to the mobile terminal.

11. The method of claim 8, wherein executing an application registered in a broadcast channel to be changed in response to a user's channel change request comprises:
determining a channel to be changed in response to the channel change request;
when the broadcast channel to be changed is a channel where broadcasting is received, receiving the broadcasting of the relevant channel; and
when the broadcast channel to be changed is a channel in which the application has been registered, executing the application registered in the relevant channel.

12. The method of claim 8, further comprising determining broadcast channel information.

13. The method of claim 8, further comprising receiving a channel change request from a user.

14. The method of claim 13, further comprising displaying the requested channel.

15. A mobile terminal for providing a broadcast receive service, the mobile terminal comprising:
a communication unit configured to communicate with a remote controller to receive a control signal of the remote controller;
a channel register unit configured to register an application installed in advance in a broadcast channel allocated to the mobile terminal to update channel information;
a channel determining unit configured to determine a channel selected by a user's remote controller manipulation;
a memory unit configured to store channel information updated by the channel register unit; and
a controller configured to process to execute an application depending on a channel change of the remote controller,
wherein the channel determining unit determines the channel information to determine an application registered in the changed channel.

16. The mobile terminal of claim 15, wherein when broadcasting is received in the changed channel, the controller processes to receive the broadcasting of the changed channel.

17. The mobile terminal of claim 15, wherein the controller incorporates the channel information updated by the channel register unit into Electronic Program Guide (EPG) information.

18. The mobile terminal of claim 15, wherein the channel register unit registers an application in a channel to which a broadcasting service has not been allocated among broadcast channels allocated to the mobile terminal.

19. The mobile terminal of claim 15, wherein the channel register unit processes to change or delete a channel in which an application has been registered in the updated channel information.

20. The mobile terminal of claim 15, further comprising:
a display unit configured to display the channel selected by the user's remote control manipulation.
